(19) United States
(12) Patent Application Publication
(10) Pub. No.: US 2010/0153476 A1
(43) Pub. Date: Jun. 17, 2010

(54) RECORDING APPARATUS AND METHOD OF CONTROLLING THE SAME

(75) Inventor: Shuichiro Matsushima, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/634,574

(22) Filed: Dec. 9, 2009

(30) Foreign Application Priority Data
Dec. 15, 2008 (JP) 2008-318562

(51) Int. Cl. G06F 12/00; G06F 17/00

(52) U.S. Cl. 707/822; 711/166; 711/115; 707/E17.01; 711/E12.001

(57) ABSTRACT

A recording apparatus including a mounting unit to mount a removable recording medium, a recording capacity obtaining unit to obtain recording capacity of the recording medium, a file format determination unit to determine a file format used in the recording medium, and a changing unit to change the file format used in the recording medium and initialize the recording medium based on a relationship between the recording capacity and the file format.

### BACKGROUND OF THE INVENTION

1. Field of the Invention

The present invention relates to a recording apparatus for recording digital data in a predetermined file format into a recording medium, and to a recording apparatus performing processing in accordance with a file format and a speed of recording data into a recording medium.

2. Related Background Art

A recent increase in the capacity of recording media and file size has caused a demand for the functional extension of conventionally used file formats. For instance, conventionally used File Allocation Table 32 (FAT32) can only handle a file size of up to FFFFFFFF (Hex) bytes (≈4 GB), because the size of a file is represented by 32 bits. To solve this problem, next-generation file formats (such as exFAT) which have extended functions are becoming increasingly widely used. However, since these file formats are not compatible with conventional file formats, several file formats are being used at the same time in the market.

On the other hand, in accordance with an increase in the quality of image data and hence an increase in bit rate, a very large amount of data is generated per unit time. Writing this data without error into a recording medium requires a correspondingly high writing speed. For instance, a Secure Digital Card (SD® card) has a “speed class” which specifies a minimum writable speed. If the speed class indicated on the label of the SD® card is “class 6”, for example, a speed of 6 MB/s is guaranteed under certain conditions. Since this minimum writable speed depends on the file format, the writable speed specified by the speed class is not ensured for the data of a file format other than the specified formats. In this case, recording may be interrupted due to an insufficient writing speed. Note that Japanese Unexamined Patent Application Publication No. 2007-26097 discloses a related method in which, when it is determined on the basis of file management information read out of a semiconductor memory that the format specifications are not specifications which have taken into consideration the memory block configuration of the semiconductor memory, recording in the semiconductor memory is controlled and a warning is issued on the basis of the determination result.

In the related technology disclosed in Japanese Unexamined Patent Application Publication No. 2007-26097, the writing speed of a recording medium is determined on the basis of the specifications and configuration of a file format. Since the writing speed is determined only on the basis of the file format information irrespective of the writable speed of the recording medium, the writing speed may not be usable, depending on the state of data fragmentation in the recording medium. For this reason, in the above-described example of using an SD® card, it is required to determine whether or not the card is usable on the basis of information about a writable speed (guaranteed minimum writing speed) which can be obtained from the card. Although the writable-speed information contained in a recording medium has been reliable hitherto, the writable-speed information is not reliable when the medium is formatted in a format other than the specified formats due to the use of a mixture of old and new file formats.

In other words, when a recording medium is formatted in a format other than the file formats that allow writing at the writable speed, the writing speed at which recording is performed in accordance with the writable speed information contained in the recording medium may be too high.

In that case, the host apparatus needs to determine that the obtained speed class information is not valid (invalid).

However, a method of determining whether or not an obtained speed class is valid has not been disclosed. In addition, it is necessary to limit some functions, such as to prohibit a recording mode for recording at a high bit rate. However, this may cause confusion among users, since a card cannot be used in a manner allowed by the speed class indicated on the label of the card.

### SUMMARY OF THE INVENTION

An aspect of the present invention provides a solution to all or at least one of the above-described problems.

In an aspect of the present invention, a recording apparatus includes a mounting unit configured to mount a removable recording medium, a recording capacity obtaining unit configured to obtain a recording capacity of the recording medium mounted in the mounting unit, a file format determination unit configured to determine a file format used in the recording medium, and a display unit configured to display a message prompting changing of the file format used in the recording medium based on a relationship between the recording capacity and the file format determined.

Further features of the present invention will become apparent from the following description of exemplary embodiments with reference to the attached drawings.

### BRIEF DESCRIPTION OF THE DRAWINGS

FIG. 1 is a block diagram illustrating a system for realizing an embodiment of the present invention.

FIG. 2 illustrates a group of control programs contained in a nonvolatile storage medium 109.

FIG. 3 illustrates a list of bit rates to be set.

FIG. 4 is a flowchart illustrating a processing sequence (card recognition processing).

FIG. 5 is a flowchart illustrating a processing sequence (speed class validity determination processing).

FIG. 6 is a flowchart illustrating a processing sequence (image quality determination processing).

FIG. 7 illustrates an exemplary display screen (user notification A).

FIG. 8 illustrates an exemplary display screen (user notification B).

FIG. 9 illustrates an exemplary display screen (card initialization screen).

FIG. 10 illustrates an exemplary display screen (card initialization screen).

FIG. 11 illustrates an exemplary display screen (card initialization confirmation screen).

FIG. 12 illustrates an exemplary display screen (movie recording screen).

FIG. 13 illustrates an exemplary display screen (movie recording screen).

### DETAILED DESCRIPTION OF THE PREFERRED EMBODIMENTS

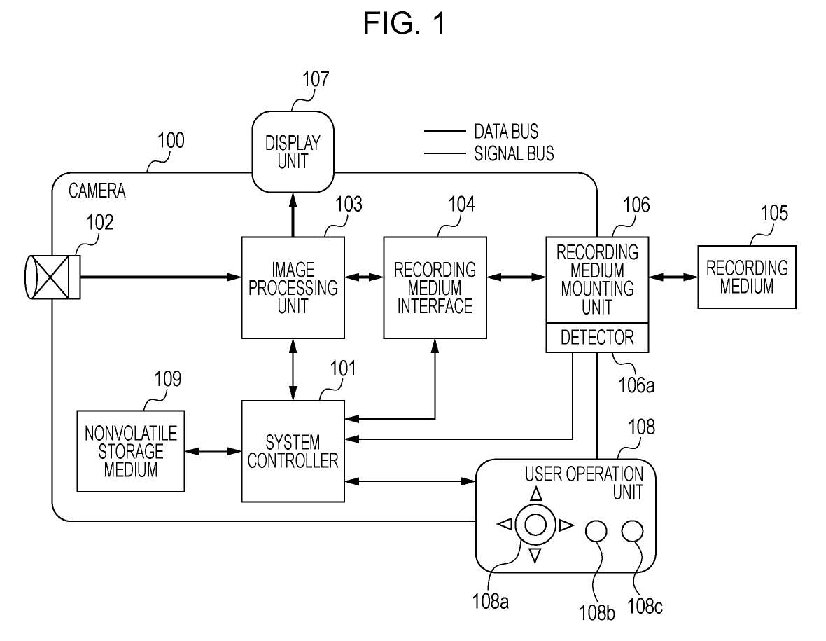

FIG. 1 illustrates a system for realizing an embodiment of the present invention. Here, steps of recording a movie in a removable recording medium (memory card) for a digital video camera (hereinafter, called a camera) are described.

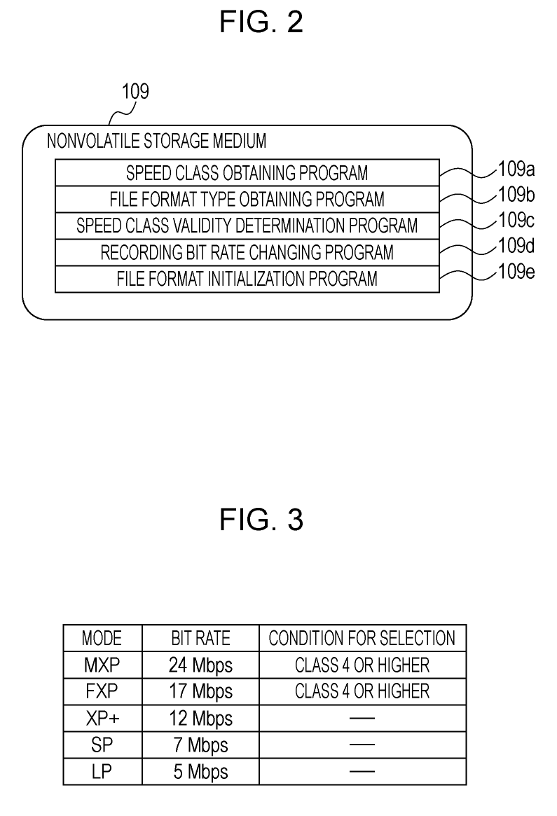

Referring to FIG. 1, a camera 100 includes a system controller 101 that controls a system and blocks for processing respective functions. When an image is recorded using a digital camera, external light passing through an image capturing unit 102 (including an optical system, a motor for controlling the optical system, and an image pickup device) forms an optical image on the surface of an image pickup device, and the image is converted into an electrical signal by the image pickup device. The electrical signal is converted into digital data by an image processing unit 103. The digital data is recorded in a recording medium 105 via a recording medium interface 104. The recording medium 105 is mounted in a recording medium mounting unit 106. The recording medium mounting unit 106 is provided with a detector 106a for detecting a recording medium to inform the system controller 101 of whether or not the recording medium 105 is mounted. To reproduce data recorded in the recording medium 105, data read from the recording medium 105 is converted by the image processing unit 103 into data which is the most appropriate for being displayed, and then displayed by a display unit 107. A user is able to operate the camera 100 by operating a user operation unit 108. The user operation unit 108 includes a cross key 108a, a set key 108b, and a menu key 108c. A nonvolatile storage medium 109 contains various programs for controlling the system controller 101 illustrated in FIG. 2. The various programs include a speed class obtaining program 109a, a file format type obtaining program 109b, a speed class validity determination program 109c, a recording bit rate changing program 109d, and a file format initialization program 109e.

The nonvolatile storage medium 109 contains a program (not shown) necessary for controlling the camera according to the present embodiment such as image capturing processing and display control. The system controller 101, by reading and executing these various programs, functions as a speed class obtaining unit, a file format type determination unit, a speed class validity determination unit, a recording bit rate changing and recording medium initializing unit.

Detailed operations of respective programs will be described later.

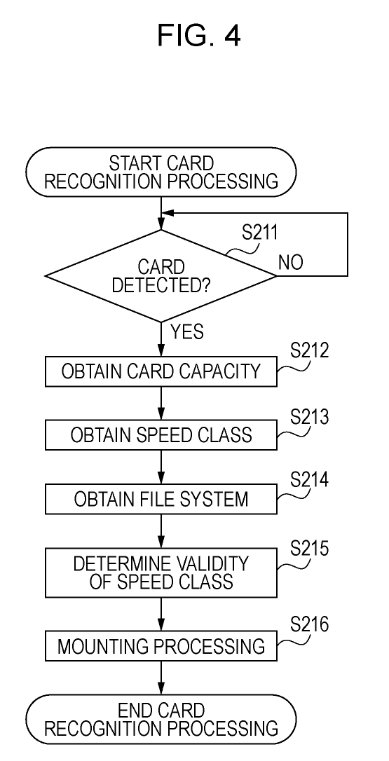

Referring to the flowchart illustrated in FIG. 4, the processing sequence of the system controller 101 at the time of recognizing a memory card will now be described. When a memory card is mounted, the detector 106a of the recording medium mounting unit 106 informs the system controller 101 of the mounting of the card (S211). Then the system controller 101 obtains management information stored in the memory card and information about the recording capacity of the card (S212). After obtaining the recording capacity, the system controller 101 obtains the speed class by referring to speed class information in the management information to obtain the recording speed information indicating the recording speed supported by the recording medium (S213). After obtaining the recording speed information, the system controller 101, by analyzing the format of the memory card, obtains the type of file system (S214). On the basis of the information obtained by these processing steps, it is determined whether or not the information about the speed class is valid (S215). The detailed processing for this determination of the speed class will be described later. Then mounting processing (initialization processing) for using the card for the camera is performed (S216) to complete the card recognition processing. Note that steps S211 to S213 need not be executed in the order described above, and may be executed in another order.

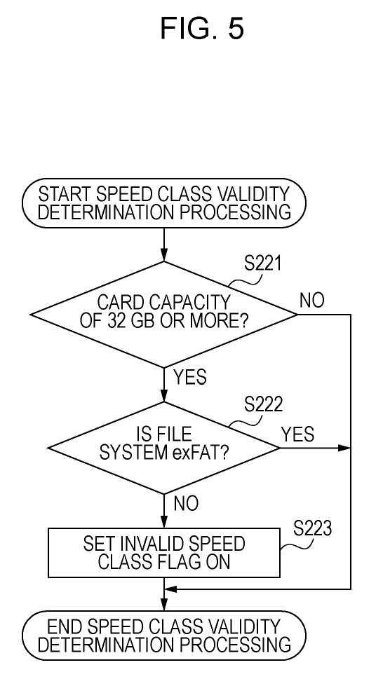

The speed class validity determination processing performed in step S215 will now be described with reference to the flowchart shown in FIG. 5. Here, determination of the capacity of the card obtained by the system controller 101 in step S212 is performed (S221), and when the capacity is determined to be 32 GB or less, the flow ends since the card uses a conventional format, and hence, the obtained speed class is valid. When the capacity of the card is determined to be more than 32 GB, determination of the file type is performed (S222). When the file system is determined to be exFAT, the flow ends since exFAT is a file format specified for a card with more than 32 GB, and hence, the speed class is valid. When the file system is determined to be a file system other than exFAT, such as FAT 32, it is determined that the original speed class which is supposed to be supported by the card is no longer valid since the card has a capacity of more than 32 GB and uses a file format which is not specified therefor. Hence, a flag showing invalid speed class is set (S216). This flag is set at the time of recognizing a card and is referred to in later processing.

In this manner, the validity of recording speed information can be determined on the basis of information about the recording capacity obtained from a memory card and information about the file format of the memory card. The use of this determination result regarding the validity of recording speed information allows for processing such as changing of a recording bit rate of a movie and initialization of a memory card by changing the file format.

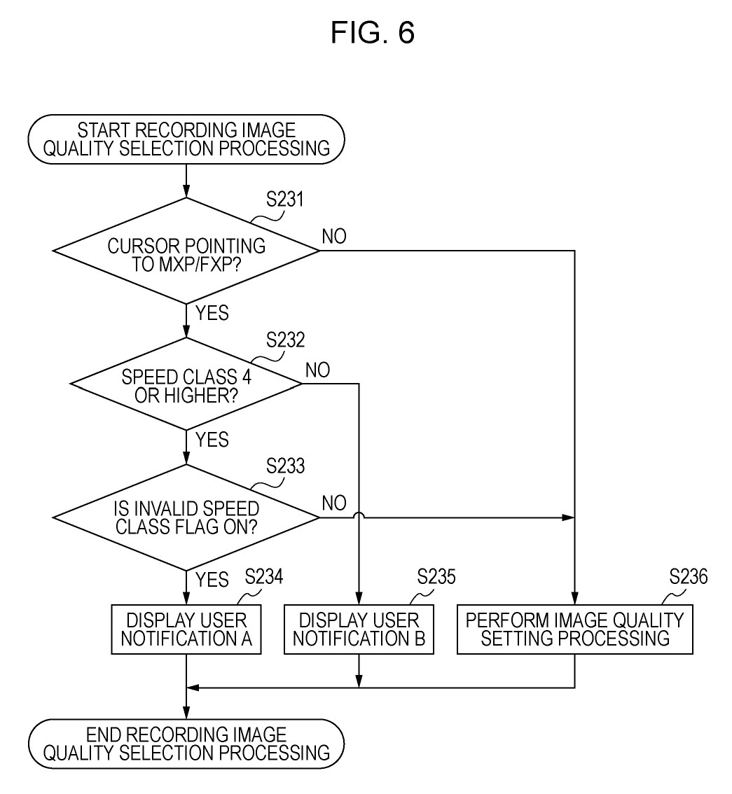

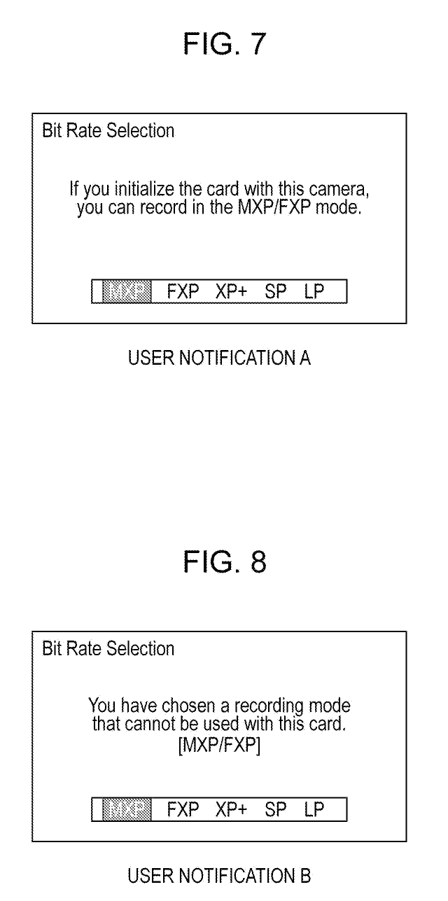

Referring to the flowchart illustrated in FIG. 6, the flow of processing for selecting a recording bit rate of a movie will now be described. The camera according to the present embodiment allows a user to set a desired bit rate selected from among the five kinds of bit rate illustrated in FIG. 3 through selection via a menu using the user selection unit 108. Here, there is a restriction that two kinds of high bit rate image quality (MXP and FXP) require a speed of class 4 or higher, and these two kinds of image quality are not selectable for a class 2 card or a card without class definition. First, the position of a cursor is detected (S231). When the cursor points to positions other than the positions of MXP and FXP, image quality is allowed to be set irrespective of the type of memory card. In this case, image quality setting processing is performed (S236). When the cursor points to MXP or FXP, speed class determination is performed (S232). Here, when the speed class is determined to be lower than 4 on the basis of the speed class obtained in step S213, a user notification B is displayed without executing the selected operation since the writing speed may not be sufficient (S235). FIG. 8 illustrates a display screen showing the user notification B. It is displayed that recording is not allowed for the card since the card is not usable for this mode of recording. When the card is determined to have a speed class equal to higher than 4, the invalid-speed-class flag is checked since recording may be possible (S233). When the valid/invalid information determined in step S215 shows that the speed class is valid, image quality setting processing is performed. When the speed class is invalid, this means that a card having a capacity of more than 32 GB is used with a file format other than exFAT, and hence, satisfactory writing is not guaranteed due to mismatching of file systems although the card itself has the capability of writing satisfactorily. Here a user notification A is displayed (S234). FIG. 7 illustrates a display screen showing the user notification A. It is displayed that if the card is to be initialized by the camera, MXP or FXP recording becomes possible since the card will be initialized in an appropriate format in accordance with the type of card. In this manner, as illustrated in FIGS. 7 and 8, the problem of user confusion due to the fact that FXP or MXP recording is not possible although the package of a card has a label indicating a speed class of 4 or higher attached thereon is solved.

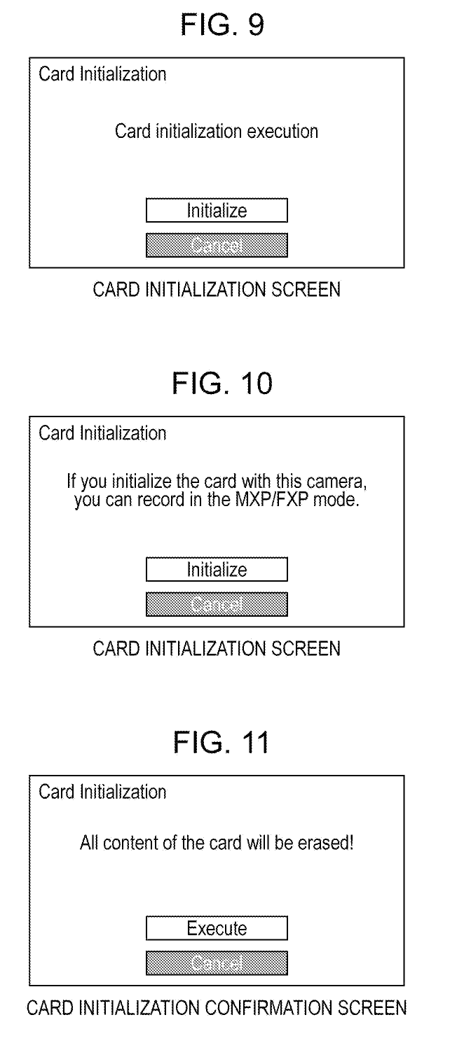

In the bit rate selection screen described above, a message is displayed, prompting initialization of a card for changing the file format of the card when there exists a mismatch between the type of the card and the file format. Referring to display screens illustrated in FIGS. 9 to 11, initialization of a card will now be described. Usually, the screen regarding the initialization of a card illustrated in FIG. 9 is displayed at the time of initialization of the card. In a state where the invalid speed class flag determined in step S215 is set, it is clearly shown, as illustrated in FIG. 10, that some functions are restricted due to mismatching of file formats. In either of the cases described above, when initialization is selected, the confirmation screen illustrated in FIG. 11 is displayed to prevent a user from erasing the content by mistake.

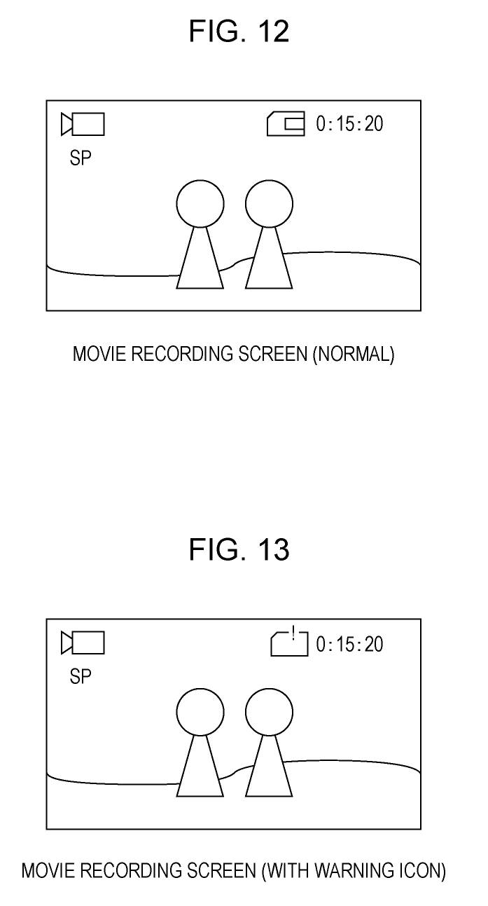

Display of a movie recording screen will now be described. FIG. 12 illustrates a normal movie recording screen, but in a state where the invalid speed class flag is set, as has been determined in step S215, a warning mark may be displayed in the card icon, as illustrated in FIG. 13, so as to let a user recognize mismatching.

As described above, a warning can be issued when a file format is used which cannot ensure that a writing speed that a recording medium is supposed to support can be used. In addition, by letting a user know the reason why a high-bit-rate recording mode cannot be used, user confusion is prevented. Furthermore, by changing the file format, it becomes possible to ensure that a writing speed that the recording medium is supposed to support can be used.

Exemplary modifications of the embodiments described above are described as other embodiments. For example, instead of obtaining information about a speed class in step S213 illustrated in FIG. 2, by checking the capacity and current file system of a recording medium, and in accordance with the relationship between the two, initialization in a different format may be prompted.

More specifically, when an old file format such as FAT32 or FAT16 is used as a file system for a recording medium that has a capacity of 32 GB or larger, a message prompting initialization in exFAT is displayed on a display unit. Such implementation is considered to work without problems, since recent recording media having a capacity of more than 32 GB generally support high-speed writing and are supposed to support exFAT to take advantage of their large capacity.

Note that the content of display prompting changing of a file format is not limited to the content described in the above embodiments, and any content which can prompt a user to change a file format is included in the scope of the present invention.

In addition to the embodiments described above, embodiments of the present invention may include a system, an apparatus, a method, a program, and a storage medium storing the program. More specifically, the present invention may be applied to a system constituted by a plurality of devices or to an apparatus constituted by one device.

The present invention includes a case in which a software program realizing the functions of the embodiments described above (program which corresponds to the flowcharts illustrated in the figures of the embodiments) is directly or remotely provided to each apparatus. The present invention also includes a case in which the functions of the embodiments described above are achieved in such a manner that a processing unit in the apparatus reads and executes the program code.

Therefore, the program code itself which is installed in a computer to realize the functional processing of the embodiments by the computer can be said to realize the present invention. In other words, the present invention includes a computer program itself for realizing the functional processing of the present invention.

In this case, the program may be of any form such as object code, a program executed by an interpreter, and script data provided to an OS, if they function as programs.

Examples of storage media for providing the program include a floppy disk, a hard disk, an optical disk, a magneto-optical disk (MO), a CD-ROM, a CD-R, a CD-RW, a magnetic tape, a non-volatile memory card, a ROM, and a DVD (DVD-ROM and DVD-R).

Another example method of providing the program is downloading the program of the invention from a home page on the Internet by accessing the home page using a browser of a client computer. An alternative method is downloading a compressed file with a self-installing capability containing the program into storage media such as a hard disk. The program code making up the program may be divided into a plurality of files so that each of the files is downloaded from a different home page. In other words, the invention also includes a WWW server allowing a plurality of users to download the program files for realizing the functional processing of the invention on computers.

Another method may be distributing to users the program of the invention in an encrypted form recorded in a storage medium such as a CD-ROM. In this case, a user who satisfies a certain condition may be allowed to download the information about a key for decryption using the Internet, and to install and execute the encrypted program on a computer by using the information about a key.

Further, the present invention also includes a case in which the functions of the embodiments described above are realized such that an OS or other software running on a computer performs part or all of the actual processing in accordance with the instructions given by the program.

Further, the present invention also includes a case in which the functions of the embodiments described above are realized such that a CPU or the like provided on a function expansion board inserted into a computer or in a function expansion unit executes part or all of the actual processing to be performed by the program according to the present invention.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Patent Application No. 2008-318562 filed Dec. 15, 2008, which is hereby incorporated by reference herein in its entirety.

What is claimed is:

1. A recording apparatus comprising:
a mounting unit configured to mount a removable recording medium;
a recording capacity obtaining unit configured to obtain a recording capacity of the recording medium mounted in the mounting unit;
a file format determination unit configured to determine a file format used in the recording medium; and
a display unit configured to display a message prompting changing of the file format used in the recording medium based on a relationship between the recording capacity obtained and the file format.

2. The recording apparatus according to claim 1, further comprising:
a recording speed information obtaining unit configured to obtain recording speed information supported by the removable recording medium; and
a validity determination unit configured to determine validity of the recording speed information obtained by the recording speed information obtaining unit,
wherein the display unit displays a message prompting changing of the file format used in the recording medium based on a determination result of the validity determination unit.

3. The recording apparatus according to claim 2, further comprising a setting unit configured to set a recording bit rate at which a movie is recorded in the recording medium,
wherein a settable recording bit rate is changed based on the determination result of the validity determination unit.

4. The recording apparatus according to claim 1, further comprising a changing unit configured to change the file format of the recording medium and to initialize the recording medium after displaying a message prompting changing of the file format of the recording medium on the display unit.

5. A method of controlling a recording apparatus including a mounting unit configured to mount a removable recording medium, the method comprising:
obtaining a recording capacity of the recording medium mounted in the mounting unit;
determining a file format used in the recording medium; and
changing the file format used in the recording medium and initializing the recording medium based on a relationship between the recording capacity and the file format.
